(19) United States
(12) Patent Application Publication
(10) Pub. No.: US 2005/0196107 A1
(43) Pub. Date: Sep. 8, 2005

(54) Optical multiplexer with improved manufacturability

(76) Inventors: Gongen Gu, San Ramon, CA (US); William D. Sterling, Pleasanton, CA (US)

Correspondence Address: Howard Cohen, 1105 The Alameda, Berkeley, CA, 94707-2501, US

(21) Appl. No.: 10/843,879

(22) Filed: May 12, 2004

Related U.S. Application Data
(60) Provisional application No. 60/549,958, filed on Mar. 4, 2004.

(51) Int. Cl. G02B 6/42

(52) U.S. Cl. 385/88

(57) ABSTRACT

An innovation in construction of a triplexer type of device features an optical wavelength separation system that permits the orientation of all transmitter and receiver elements such that their respective electronic connections can be arranged to extend in a single direction from a single package to allow a simple direct insertion into a circuit board for socket mounting, soldering or welding. The advantages of this approach include reduced handling time in a mass production setting, lowered parasitic capacitance, and reduced RFI susceptibility for improved electronic performance.

### CROSS-REFERENCE TO RELATED APPLICATIONS

This application claims priority date benefit of Provisional Application 60/549,958, filed Mar. 4, 2004.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to optical fiber communications and, more particularly, to devices that facilitate an optical/electronic interface for communication.

2. Description of Related Art

In the field of optical telecommunications it is often desirable to combine multiple data channels and multiple data types into a single fiber for distribution. In the particular field of “Fiber to Home” or “Fiber to Premises” commonly called FTTx applications, a set of 2 or more wavelengths are selected to establish 2-way communication between the Service Provider and the Service Customer. A common form of this 2-way system delivers analog data on a nominal 1550 nm wavelength carrier, downlink digital data on nominal 1480 nm wavelength carrier and up-link digital data transmitted by a nominal 1310 nm carrier. At the consumer end of the data transmission system, there is a need for an inexpensive optical-to-electronic interface that can separate two or more incoming data carrying wavelengths, and transmit one or more data carrying wavelengths into a single common fiber. To achieve the goal of an inexpensive optical to electronic interface, the interface module must be simple to handle and assemble in a manufacturing operation.

As an example a device commonly known as a triplexer has been available in the market for several years. The commonly available triplexer package has a number of disadvantages from the manufacturing standpoint. As provided, 3 multi-lead transistor type packages are arrayed at 90-degree angles in the horizontal plane. In order to install this part into a circuit board, each lead must be bent 90 degrees to be inserted into a circuit board. To comply with restrictions on bending radius and avoiding electrical contact between 9 to 12 leads, an overly complex handling is required. Also, from an electronic standpoint the resulting lead lengths are excessively long and are sources of parasitic inductance and capacitance effects that are undesirable in high frequency-high data-rate signals. The overly long electronic leads also increase the susceptibility of the circuit to radio-frequency interference.

FIG. 3 illustrates a typical prior art triplexer device. In this design an optical fiber 7 is attached to a strain relief boot 8 that is attached to a chassis 11. Inside the chassis an optical pathway (not shown) separates and directs incoming signal wavelengths to detectors which have clusters of electronic leads 9A and 9B. Also joined to the optical path is an optical emitter which has a cluster of electronic leads 10 external to the chassis 11, can send an optical signal out of the triplexer device and into the external fiber 7. The clusters of electronic leads 9A and 9B and 10 are initially contained in a horizontal plane. In order to attach this device to a circuit board, the clusters of electronic leads must be bent into a vertical direction in order to be attached to an electronic circuit board. In FIG. 4 we see a side view of the same prior art triplexer. From this side view it is possible to see the complex bending required to vertically direct the clusters of leads 9A, 9B, and 10 in a manner that allows them to be inserted into the same circuit board while avoiding electrical contact between the leads within the clusters 9A, 9B and 10. The overall design is inefficient from a manufacturing standpoint and the long unshielded leads create undesirable capacitive and inductive effects that degrade electronic performance of the devices for reasons are well known in the art.

### BRIEF SUMMARY OF THE INVENTION

The present invention generally comprises an innovation in construction for a triplexer type of device to create an optical wavelength separation system that permits the orientation of all transmitter and receiver elements such that their respective electronic connections can be arranged in a single direction from a single package to allow a simple direct insertion into the same circuit board for socket mounting, soldering or welding. The advantages of this approach include reduced handling time in a mass production setting, lowered parasitic capacitance, and reduced RFI susceptibility for improved electronic performance.

### BRIEF DESCRIPTION OF THE DRAWING

FIG. 1 is a side view showing the improved package design of the triplexer of the invention.

FIG. 2 is a bottom view show of the device shown in FIG. 1.

FIG. 3 is a top view of a prior art design for an optical multiplexer.

FIG. 4 is a side view of the prior art design of FIG. 3.

FIG. 5 is a side view showing a further embodiment of the improved package design of the triplexer featuring an industry standard dual inline package.

FIG. 6 is a bottom view of the embodiment shown in FIG. 5.

### DETAILED DESCRIPTION OF THE INVENTION

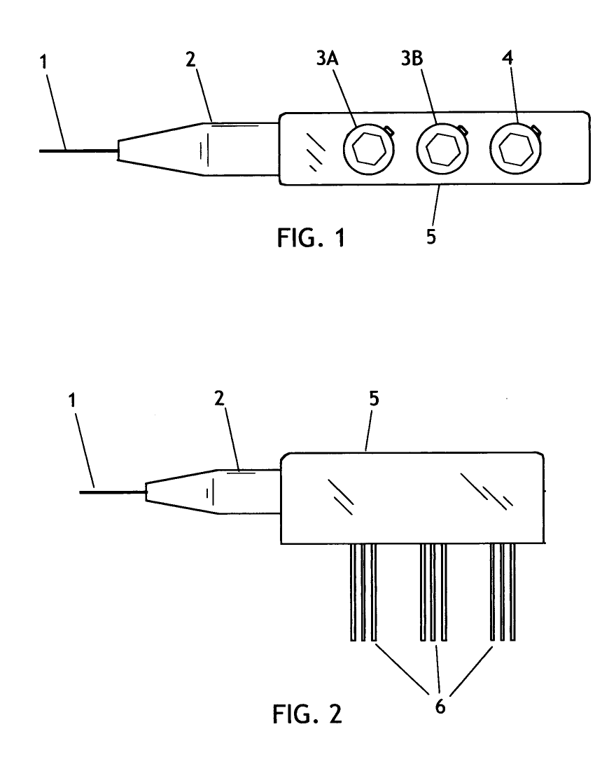

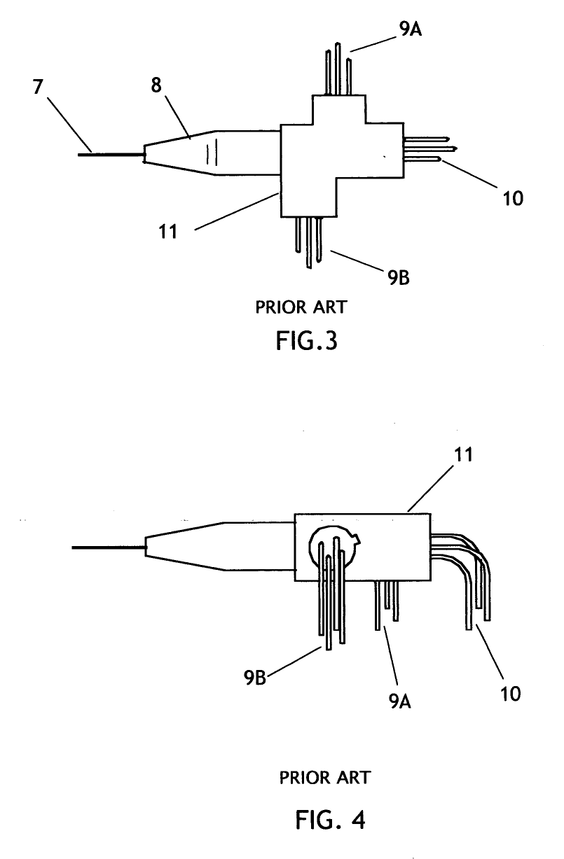

The present invention generally comprises a novel construction for a optical triplexer that enables reduced handling time in a mass production setting, lowered parasitic capacitance, and reduced RFI susceptibility for improved electronic performance. One embodiment of the new package design of a triplexer type of device is shown in FIG. 1. An optical fiber 1 is introduced to the device through a strain relief boot 2 that is attached to the device housing or chassis 5. An internal optical circuit (not shown) comprised of thin film coated components, gradient index lenses and other devices well known in the art directs the component wavelength of the optical signal carried in the optical fiber 1 to detectors. The detectors 3A and 3B are packaged in transistor type housings each with two or more electronic leads, and are inserted and fixedly mounted in the device chassis 5. An optical emitter 4 is also inserted and fixedly mounted into the device chassis 5. The order arrangement of the emitter and detector devices inserted in the chassis is selected according to the most advantageous optical design for splitting and mixing the particular signal wavelengths. It is significant that the internal optical pathway permits all three devices 3A, 3B and 4 to direct their respective clusters of electronic leads in a common direction with a minimization of lead length and without complex bending patterns. In FIG. 2 a side view of the device chassis 5 clearly shows the simplified common electronic lead orientation of the devices 3A, 3B and 4 shown as a collective group of leads 6.

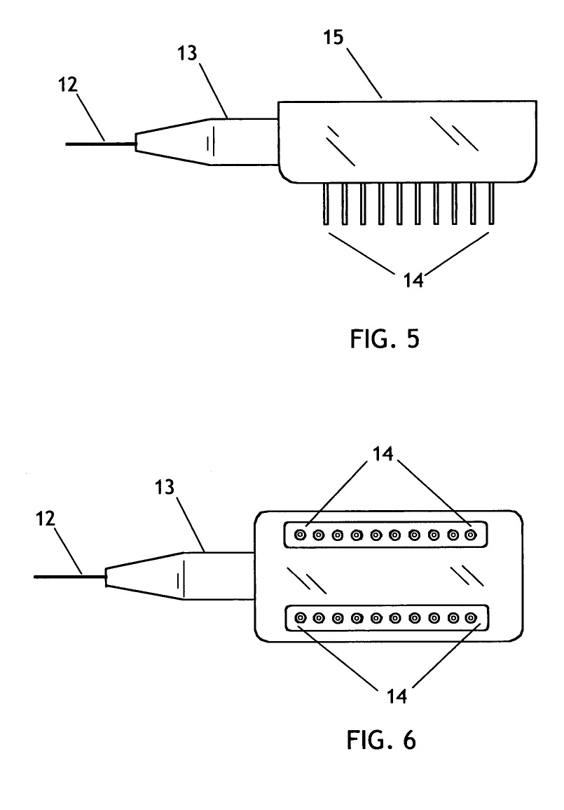

An alternative embodiment of the invention uses an industry standard Dual-in-line package to house the wavelength separation optics, emitters and detectors. In FIG. 5 an optical fiber enters a strain relief boot 13 attached to the Dual-in-line package chassis 15. The electrical leads all exit the chassis in a common direction 14. In FIG. 6 a bottom view shows the row-type orientation of the electrical leads 14.

The design is appropriate for multiple wavelength bidirectional optical communication where at least 2 incoming data wavelengths and at least 1 outgoing data wavelength are joined in a single optical fiber by an optical circuit that can combine or separate the component signal wavelengths and direct them to signal emitters or detectors.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. An improved optical electronic device, including:
a chassis for mounting electrical and optical components;
means for securing an optical fiber end in said chassis;
at least one optical detector secured in said chassis and including a first plurality of electronic leads extending outwardly from said chassis;
at least one optical emitter secured in said chassis and including a second plurality of electronic leads extending outwardly from said chassis;
said first and second pluralities of electronic leads extending in the same direction from said chassis.

2. The improved optical electronic device of claim 1, wherein said first and second pluralities of electronic leads comprise wires extending in generally parallel fashion from said chassis.

3. The improved optical electronic device of claim 1, wherein said first and second pluralities of electronic leads extend from said chassis in a standard dual-in-line format.

4. The improved optical electronic device of claim 1, wherein said at least one optical detector includes a pair of optical detectors tuned to respective different wavelengths.

5. The improved optical electronic device of claim 1, wherein said at least one optical detector is disposed within a transistor type housing secured in said chassis.

6. The improved optical electronic device of claim 1, wherein said optical emitter is disposed within a transistor type housing secured in said chassis.

7. The improved optical electronic device of claim 1, further including a flexible boot secured to the portion of said optical fiber adjacent to said chassis.

8. The improved optical electronic device of claim 1, wherein said chassis comprises an enclosed housing.

9. The improved optical electronic device of claim 4, wherein said pair of optical detectors and said optical emitter are aligned along an optical axis.

10. The improved optical electronic device of claim 9, wherein said optical fiber end is disposed on said optical axis.

11. An improved optical electronic device, including:
a chassis for mounting electrical and optical components;
means for securing an optical fiber end in said chassis;
a pair of optical detectors secured in said chassis and including a first plurality of electronic leads extending outwardly from said chassis;
at least one optical emitter secured in said chassis and including a second plurality of electronic leads extending outwardly from said chassis;
said first and second pluralities of electronic leads extending in the same direction from said chassis;
said optical detectors and said optical emitters each being disposed within a transistor type housing secured in said chassis;
said pair of optical detectors and said optical emitter and said optical fiber end being aligned along an optical axis.

12. The improved optical electronic device of claim 11, wherein said first and second pluralities of electronic leads extend from said chassis in a standard dual-in-line format.
